(19) United States
(12) Patent Application Publication
(10) Pub. No.: US 2005/0248144 A1
(43) Pub. Date: Nov. 10, 2005

(54) Vehicle acceleration sensor for seat belt retractor

(76) Inventors: John Bell, Carlisle (GB); Brian Jack, Eastriggs (GB)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/939,450

(22) Filed: Sep. 14, 2004

(30) Foreign Application Priority Data
May 7, 2004 (EP) 0425672.3

(51) Int. Cl. B60R 22/46; B60R 22/40

(52) U.S. Cl. 280/806

(57) ABSTRACT

A vehicle acceleration sensor for a seat belt retractor safety restraint has an inertial member is mounted so as to move under the influence of acceleration and deceleration forces. The inertial member is a ball mounted in a plastic cup which is mounted to pivot under inertial forces such as occur in a vehicle crash by engagement of a narrow neck portion in a mounting hole in a base member. A pivoted locking pawl is adapted to engage teeth in a ratchet wheel of the seat belt retractor to lock the seat belt retractor against webbing payout. A ring washer rests on the upper part of the ball and is adapted to restrain the movement of the ball so that the ball only moves when the level of acceleration or deceleration exceeds a predetermined threshold.

### FIELD OF THE INVENTION

The present invention relates to a vehicle acceleration sensor for a seat belt retractor for use in a vehicle occupant safety restraint.

### BACKGROUND OF THE INVENTION

Conventional seat belt retractors allow a vehicle occupant a reasonable degree of freedom for movement during normal driving conditions in order to provide a degree of comfort and allow the vehicle occupant to reach controls such as those for in car entertainment facilities. A seat belt retractor thus allows pay out of webbing when gentle tension is applied to the seat belt during normal operation, but will arrest the vehicle occupant's movement during an emergency situation. For this purpose a vehicle acceleration sensor detects a deceleration above a predetermined magnitude, which is indicative of an emergency situation, and causes the seat belt retractor to lock.

Known vehicle acceleration sensors comprise an inertial member such as a ball that moves when the vehicle rapidly decelerates, and activates a locking mechanism to lock the seat belt retractor against further payout of seat belt webbing.

Traditionally one version of a vehicle acceleration sensor comprises a steel ball resting in a plastic cup with a hinged lever resting on top of the ball. The ball is free to move in a hollow in the base of the cup. Acceleration or deceleration above a predetermined level causes the ball to ride up the curved side of the hollow and lift the hinged lever. This in turn rotates a vehicle acceleration sensor locking pawl that engages teeth in a ratchet wheel on the seat belt retractor assembly and causes a spool, holding the seat belt webbing, to lock. In this way payout of the webbing is prevented in an emergency and the vehicle occupant is safely restrained against uncontrolled movement.

The traditional vehicle acceleration sensor module has three parts: the plastic cup, the lever and the ball.

The movable parts such as the ball can create noise in a travelling vehicle because of natural vibrations. Noise hold out mechanisms are known that hold the moveable parts of the vehicle acceleration sensor mechanism to prevent them from rattling and engaging other parts, thus reducing noise levels in the seat belt retractor.

### SUMMARY OF THE INVENTION

According to the present invention there is provided a vehicle acceleration sensor for a seat belt retractor comprising: an inertial member mounted so as to move under the influence of acceleration and deceleration forces, the inertial member comprising a ball mounted in a cup that is mounted to pivot when subjected to acceleration or deceleration; a pivotable locking pawl adapted to engage teeth in a ratchet wheel of the seat belt retractor to lock the seat belt retractor against webbing payout; and a means for restraining the movement of the inertial member so that the inertial member moves when the level of acceleration or deceleration exceeds a predetermined threshold.

Preferably the means for restraining comprises a washer.

### BRIEF DESCRIPTION OF THE DRAWINGS

FIG. 1 is a cross-section of part of a seat belt retractor incorporating a vehicle acceleration sensor according to one embodiment of the present invention.

FIG. 2 is a view of part of the vehicle acceleration sensor of FIG. 1.

FIG. 3 is a schematic cross sectional view of part of a vehicle acceleration sensor according to another embodiment of the invention.

### DETAILED DESCRIPTION OF THE INVENTION

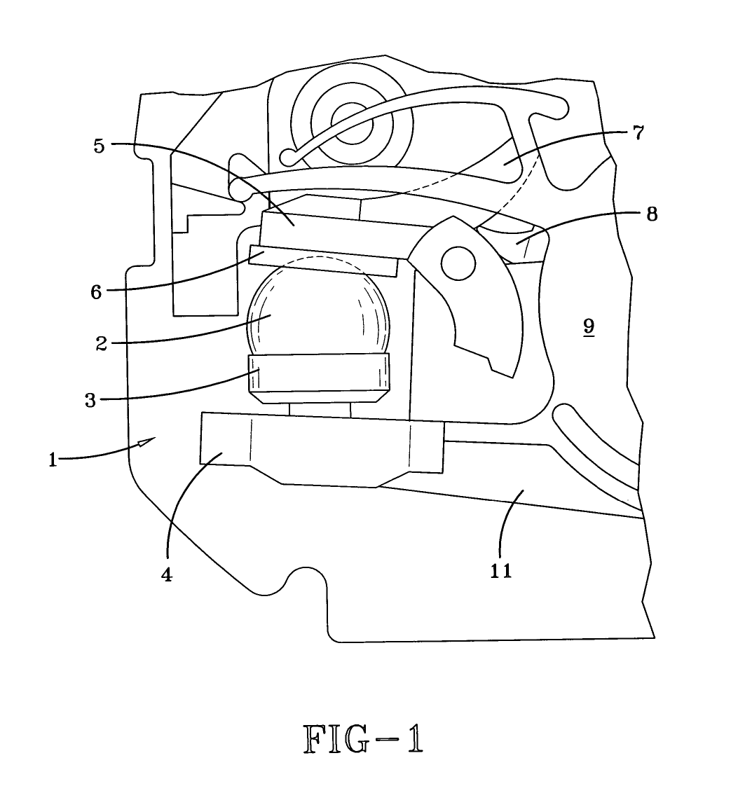

In FIG. 1 part of a standard seat belt retractor is shown with a vehicle acceleration sensor 1 according to the invention. The vehicle acceleration sensor 1 comprises a spherical metal ball such as a steel or lead ball 2 mounted in a plastic cup 3. The plastic cup 3 is mounted in a vehicle acceleration sensor base 4 in a manner that allows pivotal movement.

The base 4 is formed of a plastic material and has a mounting hole in its upper surface to receive the lower section of the cup 3.

A ring washer 6 rests on top of the steel ball 2 and a pivotable locking pawl 5 acting as a lever rests on the top curved surface of the ball 2. Movement of the inertial unit comprising the steel ball 2 the plastic cup 3 within the base mounting 4 causes the washer 6 and the pivotable locking pawl 5 to lift thus rotating the other end 7 of pivotable locking pawl 5 generally downwardly into engagement with teeth 8 which can just be seen in the cut-out in the retractor cover 9. The teeth 8 are formed in a ratchet wheel 8 connected to the spool of the retractor. When the end 7 of the pivotable locking pawl 5 engages the ratchet wheel 8 the spool is locked and further rotation, and thus further payout of the seat belt webbing, is prevented.

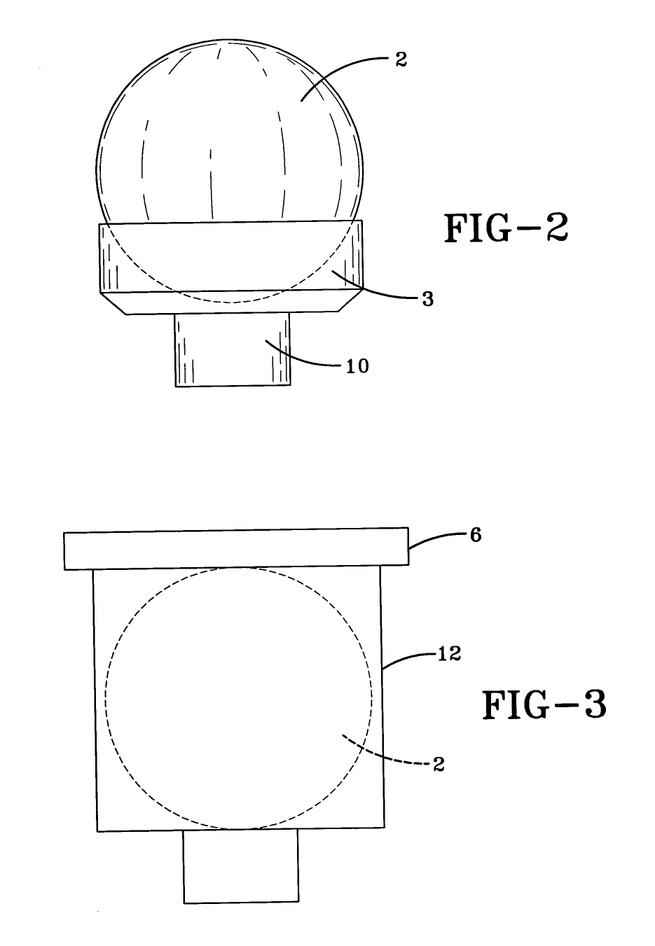

In FIG. 2 the vehicle acceleration sensor inertial unit is shown in more detail. The steel ball is shown at 2 and the plastic cup at 3. The plastic cup 3 has a narrow neck 10 which engages in the recess or hole in the vehicle acceleration sensor base mounting 4 to allow pivoting of the ball 2 and its cup 3 under inertial influences.

In FIG. 3 a different embodiment is shown in which the ball 2 is seated in a mass housing 12 with the washer 6 at the top of the housing 12. The ball 2 can be applied from the top to simplify the need for encapsulation when soft materials are needed to reduce noise further.

According to a preferred embodiment the inertial member comprises a ball 2 mounted in a 3 cup that is mounted so as to pivot when subjected to acceleration or deceleration inertial forces such as occur in a vehicle crash. The cup 3 may be formed of a plastic material and may be in the form of an egg cup having a wide upper section adapted to receive the ball 2, and a narrow lower neck 10 adapted to fit in a mounting hole in a balanced manner so that it can tip in any direction in a plane generally parallel to the mounting hole. The washer 6 may be a relatively simple traditional ring washer that rests on the upper part of the ball, and abuts the pivotable locking pawl, which acts as a sensor lever. The washer may be attached to the pivotable locking pawl or the ball.

The ball 2 effectively acts as the vehicle acceleration sensor mass and the upper curved surface of the ball takes the place of the activating lever in a traditional vehicle acceleration sensor.

Many changes and modifications in the above-described embodiments of the invention can, of course, be carried out without departing from the scope thereof. Accordingly, that scope is intended to be limited only by the scope of the appended claims.

1. A vehicle acceleration sensor for a seat belt retractor comprising:
an inertial member mounted so as to move under the influence of acceleration and deceleration forces, the inertial member comprising a ball mounted in a cup that is mounted to pivot when subjected to acceleration or deceleration;
a pivotable locking pawl adapted to engage teeth in a ratchet wheel of the seat belt retractor to lock the seat belt retractor against webbing payout; and
a means for restraining the movement of the inertial member so that the inertial member moves when the level of acceleration or deceleration exceeds a predetermined threshold.

2. The vehicle acceleration sensor for a seat belt retractor according to claim 1 wherein the means for restraining comprises a washer.

3. The vehicle acceleration sensor for a seat belt retractor according to claim 2 wherein the washer rests on an upper part of the inertial member.

4. The vehicle acceleration sensor for a seat belt retractor according to claim 3 wherein the washer is a ring washer wherein a side of the ring washer abuts the inertial member and the and another side of the ring washer abuts the pivotable locking pawl.

5. The vehicle acceleration sensor for a seat belt retractor according to claim 4 wherein the washer is attached to the pivotable locking pawl.

6. The vehicle acceleration sensor for a seat belt retractor according to claim 3 wherein the washer is attached to the inertial member.

7. The vehicle acceleration sensor for a seat belt retractor according to claim 4 wherein the washer is attached to the inertial member.

8. The vehicle acceleration sensor for a seat belt retractor according to claim 1 wherein the cup comprises a plastic material.

9. The vehicle acceleration sensor for a seat belt retractor according to claim 1 wherein the inertial member comprises stainless steel.

10. The vehicle acceleration sensor for a seat belt retractor according to claim 1 wherein the inertial member comprises lead.

11. A vehicle acceleration sensor for a seat belt retractor comprising:
an inertial member mounted so as to move under the influence of acceleration and deceleration forces, the inertial member comprising a metal ball mounted in a plastic cup that is mounted to pivot when subjected to acceleration or deceleration, the cup having a shape like an egg cup with a wide upper section adapted to receive the ball, and a narrow lower neck part adapted to fit in a mounting hole in a balanced manner so that the cup can tip in any direction in a plane generally parallel to the mounting hole;
a pivotable locking pawl adapted to engage teeth in a ratchet wheel of the seat belt retractor to lock the seat belt retractor against webbing payout; and
a means for restraining the movement of the inertial member so that the inertial member moves when the level of acceleration or deceleration exceeds a predetermined threshold.

12. The vehicle acceleration sensor for a seat belt retractor according to claim 11 wherein the mounting hole for the neck part is formed in a mounting base member.

13. The vehicle acceleration sensor for a seat belt retractor according to claim 11 wherein the means for restraining comprises a washer.

14. The vehicle acceleration sensor for a seat belt retractor according to claim 13 wherein the washer rests on an upper part of the inertial member.

15. The vehicle acceleration sensor for a seat belt retractor according to claim 13 wherein the washer is a ring washer wherein a side of the ring washer abuts the inertial member and the and another side of the ring washer abuts the pivotable locking pawl.

16. The vehicle acceleration sensor for a seat belt retractor according to claim 15 wherein the washer is attached to the pivotable locking pawl.

17. The vehicle acceleration sensor for a seat belt retractor according to claim 14 wherein the washer is attached to the inertial member.

18. The vehicle acceleration sensor for a seat belt retractor according to claim 15 wherein the washer is attached to the inertial member.
